(19) United States
(12) Patent Application Publication
(10) Pub. No.: US 2002/0023099 A1
(43) Pub. Date: Feb. 21, 2002

(54) Communications device

(76) Inventor: Heino Wendelrup, Malmo (SE)

Correspondence Address: Ronald L. Grudziecki, Esq., BURNS, DOANE, SWECKER & MATHIS, L.L.P., P.O. Box 1404, Alexandria, VA, 22313-1404, US

(21) Appl. No.: 09/892,460

(22) Filed: Jun. 28, 2001

Related U.S. Application Data
(60) Provisional application No. 60/217,026, filed on Jul. 11, 2000.

(30) Foreign Application Priority Data
Jun. 30, 2000 (GB) 0016155.4

(51) Int. Cl. G06F 17/30

(52) U.S. Cl. 707/200

(57) ABSTRACT

There is described a system for storing information, using a mobile communications device such as a mobile phone. The phone has a connection to a network infrastructure, over a mobile communications network such as a cellular radio network.

Information can be stored by the user either in a storage location within or attached to his phone, or in a storage location which forms part of the network infrastructure. The user can be given the option of selecting a preferred storage location, but the system can also be transparent, so that the user does not need to know where any specific item is being stored.

Similarly, information can be retrieved by the user, without the user needing to know where the information was stored.

### TECHNICAL FIELD OF THE INVENTION

This invention relates to a mobile communications device, and in particular to a device which can communicate over a network such as a mobile radio communications network.

### BACKGROUND OF THE INVENTION

It is necessary to store information, for use with mobile communication devices. For example, mobile phones typically include phone book functions, which allow a user to store frequently dialled numbers, so that they can be accessed, without requiring the user to remember the numbers.

A device such as a mobile phone includes an internal memory, which can store information of this type.

Mobile phones which operate in the GSM system also have Subscriber Identity Module (SIM) cards, which can also be used to store information of this type.

It is also known to provide additional memory in the form of a memory card or a memory stick, in particular for use with a mobile communications device in the form of a personal digital assistant (PDA).

Further, in the case of mobile phones which are enabled to access networks using the wireless application protocol (WAP), it is possible to download large files, for example images or sound files compressed using the MP3 format.

It is known to provide a MP3 player, which can plug into a mobile phone, and provides the storage capacity for files compressed in that format.

As mobile communication devices become more able to access the internet, it becomes more useful for them to be able to store large files. However, it is relatively expensive to provide memory in these formats. Moreover, it is relatively inconvenient for the user, either to have to carry a separate storage medium, or to have a storage device connected permanently to the mobile communications device.

### SUMMARY OF THE INVENTION

According to one aspect of the present invention, data can be stored from a mobile communications device over a mobile communications network to a remote storage device.

This allows the user to have access to increased storage capacity, in a convenient way.

In one preferred embodiment of the invention, when a user stores data, he is not informed whether it is stored on the communications device itself, or on a separate memory device connected thereto, or on a remote storage device accessed over the communications network.

This has the advantage that the user need not be concerned with the storage requirements.

In one preferred embodiment of the invention, the mobile communications device is connected to a communications network in such a way that it has a permanent connection. For example, the device may be connected to the network using the General Packet Radio System (GPRS).

This has the advantage that data can be stored to, or retrieved from, a remote storage device accessed over the network at any time, without the necessity to establish a connection specifically for the storage or retrieval.

According to another aspect of the present invention, a user of a mobile communications device can retrieve data stored in a remote storage device.

In one preferred embodiment, the user can retrieve stored data, without specifying whether the data is stored on the mobile communications device, or on a storage medium connected thereto, or on the remote storage device.

In one preferred embodiment, the user is presented with a list of stored data items, including items stored on the mobile communications device, or on a storage medium connected thereto, and items stored on the remote storage device. Preferably, no distinction is made between such items on said list.

In one preferred embodiment, the user is presented with a list of stored data items, including items stored by the user, and items stored on the remote storage device, the items stored centrally on the remote storage device being accessible by multiple users. Preferably, the list does not distinguish between such items.

### BRIEF DESCRIPTION OF DRAWINGS

FIG. 1 is a block schematic diagram of a system in accordance with an aspect of the present invention.

FIG. 2 is an illustrative example of a screen display used during implementation of the present invention.

FIG. 3 is an illustrative representation of a second screen display presented during implementation of the invention.

FIG. 4 is an illustrative representation of a third screen display presented during implementation of the invention.

FIG. 5 is an illustrative representation of a fourth screen display presented during implementation of the invention.

### DETAILED DESCRIPTION OF PREFERRED EMBODIMENTS

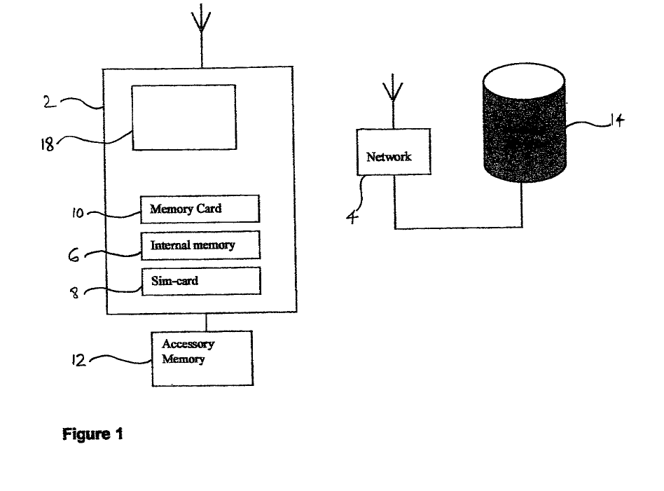

FIG. 1 shows a system in accordance with the invention. A portable mobile communications device 2, such as a mobile phone, personal digital assistant (PDA), electronic organizer, or communicator device, is in contact over a mobile network 4. The network 4 may be a cellular or satellite radio network, for example.

In accordance with aspects of the invention, a user of the device 2 has different options available for storing information. For example, the user may wish to store personal information such as diary entries; information relating to use of the device 2, such as a list of frequently used phone numbers; information in the form of SMS or e-mail messages received on the device 2; or other data files, such as image files or MP3-format compressed sound files, which may for example have been downloaded over the network 4 using the device 2.

In this example, the options available to the user for storing this information include the internal memory 6 of the device 2, which may for example be in the form of flash memory or EEPROM; a SIM-card 8; or a memory card 10, which can be connected to the device 2 to increase the available memory thereof. Similarly, a smart media card or memory stick can similarly be connected to the device 2 to increase its available storage capacity.

Another available option for information storage is a memory which forms part of an accessory 12. For example, a mobile phone may have a MP3 player as an available accessory therefor, and this device will include memory for storing files in MP3 format, as well as for decompressing such files in a playback mode.

In accordance with aspects of the present invention, a user of the device 2 also has the option of storing information on a memory server 14, which is located remote from the device 2, and can be accessed over the network 4. For example, the server 14 may be similar to conventional file servers used in data networks, and may form part of a network infrastructure provided by a mobile communications service provider.

The network 4 is preferably a General Packet Radio System (GPRS) network, or other network of a type in which a user has a permanent connection. This allows the user to store information to the memory server 14 over the network 4, or to retrieve information from the memory server 14 over the network 4, at any time, without needing to set up a call.

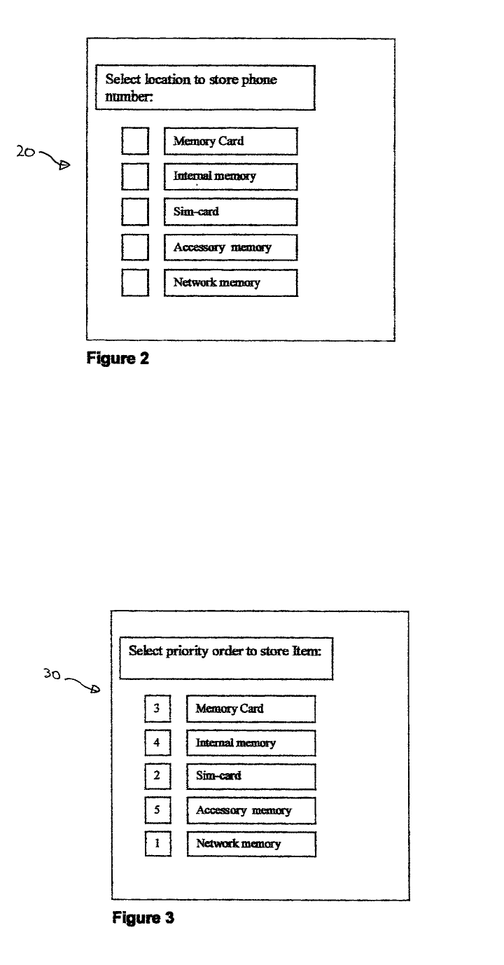

The device 2 has a display 18, which may be of a conventional type, and FIG. 2 shows the text provided on the display 18, in one implementation of the invention. When a user indicates that he wishes to store a phone number, he is presented with a screen display 20, which lists the available storage locations, and invites the user to select the location at which he wishes to store the phone number. In the illustrative example of FIG. 2, the user is presented with a list which includes a memory card 10, internal memory 6 of the phone, SIM card 8, accessory memory 12, and memory server 14. However, it will be appreciated that not all of these options need be available.

When a user selects one of the storage locations, the input phone number is then stored at the selected location.

FIG. 3 shows a screen display 30 which can be provided to the user on the display 18 of the device 2, in an alternative implementation of the invention. In this case, the user is presented with the same list of available storage locations, for example when he first attempts to store any item of information on first use of the device 2. In this case, however, the user is invited to select a priority order for storage of information.

In the example of FIG. 3, the user has selected a priority order in which the network memory server 14 is his first selection, the SIM card 8 is his second preference, and so on.

Thereafter, whenever the user selects any option to store any item of information, a controller within the device 2 attempts to store that item of information to a storage location selected from the preference list. However, it may be the case that a selected storage location is unavailable, for example because there is no available connection over the network to allow use of the network memory device, or because the storage location has no available storage capacity, for example in the case of an internal memory or a SIM card, or because the selected location is an accessory memory and no accessory is connected to the device. In that situation, the information is stored not at the storage location which is the first preference selected by the user, but is instead stored at the storage location which is the next available highest preference.

Advantageously, having made a preference list of storage locations, the user does not need to be informed of which storage location is used for the storage of any specific piece of information. Moreover, if the user has a permanent connection to the network, then, when he is retrieving information, he does not need to know whether he is retrieving that information from a storage location on his device, or from a remote location over the network.

Aspects of the invention also relate to the retrieval of information which may have been stored in any one of multiple locations. Again, in accordance with the preferred embodiments of the invention, the user does not need to know where information is stored, in order to be able to retrieve it.

For example, a user may wish to store his personal list of frequently used telephone numbers. In accordance with the invention, some of these numbers may be stored on the phone itself, or on a SIM-card which is usually present in the phone, while others may be stored on a separate device, for example a network storage device.

Advantageously, the phone is able to recall stored information from wherever it is stored, and present this information to the user in a helpful way. For example, the controller of the phone is programmed such that, when scrolling down an alphabetical list of stored telephone numbers, it can form the list by searching all of the available memory locations, retrieving the next required item of stored information, and reintegrating the items into a single alphabetical list.

Similarly, a phone user may wish to access a file in MP3 format, to play on an MP3 player provided as a detachable accessory for the phone. In that case, the controller of the phone is able to access MP3 format files which have been stored for example on a network storage device, on a separate memory device such as a memory card, or on the MP3 player itself, and the user may be presented with a scrollable list of available files. The user will therefore not need to know where a selected file is stored.

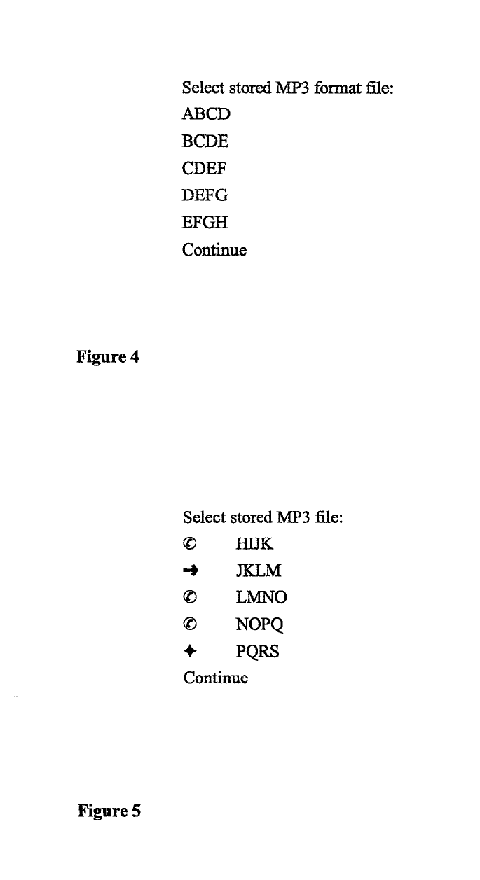

FIG. 4 shows a screen display presented to a user, after he has indicated that he wishes to retrieve a file in MP3 format. The screen display lists the available files, or as many of the available files can be shown on the display at one time, and the user is invited either to select one of them, for example by clicking a cursor on the selected item, or to continue showing more of the available items.

The screen display does not identify the storage locations of the respective items. Further, the screen display does not identify the sources of the available items.

FIG. 5 shows an alternative form of screen display which may be presented to a user, after he has indicated that he wishes to retrieve a file in MP3 format. Again the screen display lists the available files, or as many of the available files can be shown on the display at one time, and the user is invited either to select one of them, for example by clicking a cursor on the selected item, or to continue showing more of the available items.

In this case, however, displayed with each listed file there is an icon which identifies the storage location of the file. For example, in this case, symbol → can indicate that file JKLM is stored on the MP3 player itself, symbol [symbol] can indicate that files HIJK, LMNO and NOPQ are stored on a remote network server, while symbol [symbol] can indicate that file PQRS is stored on a memory card which is at present attached to the communications device.

Again, in a similar way, a phone user may wish to access a file in MPEG or other video compression format, to play a video clip on a video player provided as a detachable accessory for the phone. In that case, the controller of the phone is able to access MPEG format files which have been stored for example on a network storage device, on a separate memory device such as a memory card, or on the MPEG player itself, and the user may be presented with a scrollable list of available files. Thus, again, the user will not need to know where a selected file is stored.

Again, alternatively, the list may indicate the storage locations of the files.

The invention has been described above with reference to the storage of information by a user of a mobile communications device, and the retrieval of such information. However, the invention also provides the possibility that the network storage device 14, described above with reference to FIG. 1, may contain stored information which is provided by a central source, and is accessible by multiple users.

For example, an organisation may place its internal telephone directory on a memory server, and make that accessible to all members of that organisation. Then, when a member of the organisation accesses the network through his mobile phone, he is identifiable as a member of the organisation. That person then has access to personal telephone numbers which he has stored, and which might have been stored on the phone or on the SIM-card or on the network storage device as described above, and also to the telephone numbers of members of the organisation, those numbers having been stored centrally on the network. Again, the user can be presented with a scrollable list of numbers which includes all of the numbers from the different sources, without the user needing to know who input the information, or where it had been stored.

Alternatively, the list may indicate the source of the information and/or its storage location.

In the same way, a user can gain access to centrally stored data files of any type.

A network provider can make a charge for storing and/or accessing files on a network memory server, and a mobile phone account can be used as a method of payment for such access charges.

There is therefore provided a system which allows information to be stored in different locations, and retrieved from such locations, while appearing transparent to the user. That is, the user does not need to know which storage location is used.

1. A method of storing information from a mobile communications terminal, the method comprising determining a storage location based on predetermined criteria, and storing the information to said storage location.

2. A method of storing information from a mobile communications terminal, the method comprising:
presenting to a user a list of available storage locations, the available storage locations including at least one storage location in said terminal and at least one storage location accessible over a mobile communications network;
determining a preferred storage location selected by the user; and
storing the information at a used storage location, without informing the user of the used storage location.

3. A method of storing information from a mobile communications terminal, the method comprising:
presenting to a user a list of available storage locations, the available storage locations including at least one storage location in said terminal and at least one storage location accessible over a mobile communications network;
storing an order of preference of said storage locations, selected by the user; and,
when information is to be stored:
determining a storage location to be used, based on the order of preference selected by the user; and
storing the information at the used storage location, without informing the user of the identity of the used storage location.

4. A method of storing information from a mobile communications terminal, the method comprising:
presenting to a user a list of available storage locations, the available storage locations including at least one storage location in said terminal and at least one storage location accessible over a mobile communications network;
determining a preferred storage location selected by the user; and
storing the information at a used storage location, without informing the user of the used storage location.

5. A method as claimed in claim 4, comprising:
storing the information at a first preferred storage location selected by the user, if sufficient storage is available there; and
storing the information at a second preferred storage location selected by the user, if insufficient storage is available at the first preferred storage location.

6. A method of storing information from a mobile communications terminal, the method comprising:
selecting a storage location from a list including at least one storage location in said terminal and at least one storage location accessible over a mobile communications network, the selection being made in accordance with predetermined criteria; and
storing the information at the selected storage location.

7. A method of storing information from a mobile communications terminal, the method comprising:
presenting to a user a list of available storage locations, the available storage locations including at least one storage location in said terminal and at least one storage location accessible over a mobile communications network;
storing the information at a first preferred storage location selected by the user, if sufficient storage is available there; and
storing the information at a second preferred storage location selected by the user, if insufficient storage is available at the first preferred storage location.

8. A method of retrieving information to a mobile communications terminal, the method comprising:
presenting to a user a list of available data items, the available data items including at least one data item stored at a storage location in said terminal and at least one data item stored at a storage location accessible over a mobile communications network.

9. A method of retrieving information as claimed in claim 8, comprising presenting the list of available data items, without informing the user of their respective storage locations.

10. A method of retrieving information as claimed in claim 8, comprising presenting the list of available data items, together with an indication of their respective storage locations.

11. A method of retrieving information as claimed in claim 8, wherein the user can retrieve stored data, without specifying whether the data is stored on the mobile communications device, or on a storage medium connected thereto, or at the remote storage device.

12. A method of retrieving information as claimed in claim 8, wherein the user is presented with a list of stored data items, including items stored by the user, and items stored on the remote storage device, the items stored centrally on the remote storage device being accessible by multiple users.

13. A method of retrieving information to a mobile communications terminal, the method comprising:
presenting to a user a list of available data items, the available data items including at least one data item stored by the user, and at least one data item stored by a central source and accessible by multiple users.

14. A method of retrieving information as claimed in claim 13, wherein the list does not indicate the source of the data items.

15. A mobile communications device, adapted to store information in accordance with a method as claimed in any of claims 1 to 7.

16. A mobile communications device as claimed in claim 15, in the form of a mobile phone.

17. A mobile communications device, adapted to retrieve information in accordance with a method as claimed in any of claims 8 to 14.

18. A mobile communications device as claimed in claim 17, in the form of a mobile phone.
